(19) United States
(12) Patent Application Publication
(10) Pub. No.: US 2023/0107835 A1
(43) Pub. Date: Apr. 6, 2023

(54) FINING PACKAGES FOR GLASS COMPOSITIONS

(71) Applicant: CORNING INCORPORATED, Corning, NY (US)

(72) Inventors: Tiphaine Fevre, Paris (FR); Sinue Gomez-Mower, Corning, NY (US); Gloria Masini, Pisa (IT); Irene Mona Peterson, Elmira Heights, NY (US); Katherine Rose Rossington, Corning, NY (US)

(21) Appl. No.: 17/954,928

(22) Filed: Sep. 28, 2022

Related U.S. Application Data
(60) Provisional application No. 63/251,089, filed on Oct. 1, 2021.

(51) Int. Cl. C03C 1/00; C03C 3/118; C03C 3/11

(52) U.S. Cl. CPC C03C 1/004; C03C 3/118; C03C 3/11; A61J 1/065

(57) ABSTRACT

A fining package for a glass composition may include cerium dioxide (CeO₂) and tin oxide (SnO₂). CeO₂ may be present in an amount of 0.08 to 0.5 wt % of the glass composition, and SnO₂ may be present in an amount of 0.02 to 0.23 wt % of the glass composition. The glass composition may be used to form glass tubing. The glass tubing may be used to form a pharmaceutical packaging. For example, the pharmaceutical packaging may comprise an ampoule. The fining package may further include chloride (Cl) in an amount of 0 to 0.03 wt % of the glass composition. In some instances, the fining package may be Cl-free. In some instances, the fining package may be F-free. The glass composition may comprise a borosilicate glass composition. The glass composition may comprise an aluminosilicate glass composition.

### CROSS-REFERENCE TO RELATED APPLICATIONS

This application claims the benefit of priority under 35 U.S.C. § 119 of U.S. Provisional Application Ser. No. 63/251,089 filed on Oct. 1, 2021, the content of which is relied upon and incorporated herein by reference in its entirety.

### FIELD OF THE DISCLOSURE

This disclosure generally relates to glass fining and particularly relates to fining packages for glass compositions to be used for glass tubing and pharmaceutical packaging.

### BACKGROUND

Due to safety considerations, regulatory bodies analyze packaging materials in which pharmaceuticals are stored or administered from. For instance, regulatory bodies limit the type and amount of materials present in pharmaceutical packaging, such as closed ampoules. Such pharmaceutical packaging is made of glass, which due to the type of material and the industrial manufacturing processes used, is typically not washed before the ampoules are filled with the respective pharmaceutical composition. Some processes by which glass is manufactured at an industrial scale involve materials that are considered toxic or that can be present in amounts that may not be considered safe. For example, fining is a process by which glass is formed that may involve regulated materials. Fining agents are introduced to the glass composition to clear the gas or bubbles from the composition, thereby reducing bubbles in the formed glass and increasing clarity of the glass.

A typical fining agent for borosilicate glasses is sodium chloride (NaCl), which is particularly efficient for the borosilicate glasses. During such conventional fining, the NaCl recondenses on the internal walls of glass tubing during converting. Closed ampoules are opened just before filling, such as through a flame or cut, and thus are typically unable to be washed preliminarily Because closed ampoules are not typically washed before filling, and because the NaCl remains on the internal walls of the ampoules, the NaCl may mix with the fill fluid when the ampoules are filled. However, for such glass tubing to be used as closed ampoules for pharmaceutical packaging, the glass composition needs to contain a level of chloride (Cl) that is low enough to meet European Pharmacopoeia (EP) requirements. Per edition 10.4 of the European Pharmacopoeia, the test for chlorides for sterilized water for injections is a maximum 0.5 ppm for containers with a nominal volume of 100 mL or less.

In some instances, borosilicate glasses with a low Cl content may be used to attempt to achieve a level of chloride low enough to meet the EP requirements. To address fining of glasses with a low chloride content, fining agents such as As₂O₃, SbO₃, F, CeO₂, or SnO₂ are typically used. However, when fining glass for pharmaceutical applications, fining agents As₂O₃ and Sb₂O₃ are avoided due to toxicity, which leads to fining packages that are complex, include multiple fining agents, and are expensive due to the increased amounts and types of raw materials. Despite the complexity, such fining packages typically have a lower fining quality than using NaCl as a fining agent. Therefore, a need exists for a simple, low-cost fining package for use in glass pharmaceutical packaging that maintains the fining performance as well as the glass and product properties.

### SUMMARY

According to a first (1) aspect of this disclosure, a fining package for a glass composition is provided comprising: cerium dioxide (CeO₂) in an amount of 0.08 to 0.5 wt % of the glass composition, and tin oxide (SnO₂) in an amount of 0.02 to 0.23 wt % of the glass composition.

In a second (2) aspect, the fining package according to any of the preceding aspects is provided, further comprising chloride (Cl) in an amount of 0 to 0.03 wt % of the glass composition.

In a third (3) aspect, the fining package according to any of the preceding aspects is provided, wherein the fining package is Cl-free.

In a fourth (4) aspect, the fining package according to any of the preceding aspects is provided, wherein the fining package is F-free.

In a fifth (5) aspect, the fining package according to any of the preceding aspects is provided, wherein the glass composition comprises: SiO₂ in an amount of 70 to 76 wt % of the glass composition; B₂O₃ in an amount of 9 to 13.5 wt % of the glass composition; Al₂O₃ in an amount of 4 to 8 wt % of the glass composition; TiO₂ in an amount of 0 to 0.1 wt % of the glass composition; Fe₂O₃ in an amount of 0 to 0.1 wt % of the glass composition; BaO in an amount of 0 to 0.1 wt % of the glass composition; CaO in an amount of 0 to 3 wt % of the glass composition; Na₂O in an amount of 5 to 8.5 wt % of the glass composition; K₂O in an amount of 0.5 to 3 wt % of the glass composition; MgO in an amount of 0 to 1 wt % of the glass composition; Cl in an amount of 0 to 0.03 wt % of the glass composition; F in an amount of 0 to 0.02 wt % of the glass composition; CeO₂ in an amount of 0.08 to 0.5 wt % of the glass composition; SnO₂ in an amount of 0.02 to 0.23 wt % of the glass composition; and ZrO₂ in an amount of 0 to 0.08 wt % of the glass composition.

In a sixth (6) aspect, the fining package according to any of the preceding aspects is provided, wherein the glass composition comprises: SiO₂ in an amount of 70 to 74 wt % of the glass composition; B₂O₃ in an amount of 10 to 13.5 wt % of the glass composition; Al₂O₃ in an amount of 5 to 7 wt % of the glass composition; TiO₂ in an amount of 0 to 0.03 wt % of the glass composition; Fe₂O₃ in an amount of 0 to 0.04 wt % of the glass composition; BaO in an amount of 0 to 0.04 wt % of the glass composition; CaO in an amount of 0.5 to 2.3 wt % of the glass composition; Na₂O in an amount of 6.5 to 7.5 wt % of the glass composition; K₂O in an amount of 1.0 to 1.8 wt % of the glass composition; MgO in an amount of 0 to 0.1 wt % of the glass composition; Cl in an amount of 0.01 to 0.03 wt % of the glass composition; F in an amount of 0 to 0.02 wt % of the glass composition; CeO₂ in an amount of 0.08 to 0.2 wt % of the glass composition; SnO₂ in an amount of 0.02 to 0.12 wt % of the glass composition; and ZrO₂ in an amount of 0 to 0.08 wt % of the glass composition.

In a seventh (7) aspect, the fining package according to any of the preceding aspects is provided, wherein the glass composition comprises: SiO₂ in an amount of 70 to 73 wt % of the glass composition; B₂O₃ in an amount of 10.5 to 13.2 wt % of the glass composition; Al₂O₃ in an amount of 5 to 7 wt % of the glass composition; TiO₂ in an amount of 0 to 0.03 wt % of the glass composition; Fe₂O₃ in an amount of 0 to 0.04 wt % of the glass composition; BaO in an amount of 0 to 0.04 wt % of the glass composition; CaO in an amount of 1 to 2.3 wt % of the glass composition; Na₂O in an amount of 6.5 to 7.3 wt % of the glass composition; K₂O in an amount of 1.0 to 1.5 wt % of the glass composition; MgO in an amount of 0 to 0.1 wt % of the glass composition; Cl in an amount of 0.01 to 0.02 wt % of the glass composition; F in an amount of 0 to 0.02 wt % of the glass composition; CeO₂ in an amount of 0.08 to 0.2 wt % of the glass composition; SnO₂ in an amount of 0.02 to 0.12 wt % of the glass composition; and ZrO₂ in an amount of 0 to 0.08 wt % of the glass composition.

In an eighth (8) aspect, the fining package according to any of the preceding aspects is provided, wherein the glass composition comprises a borosilicate glass composition.

In a ninth (9) aspect, the fining package according to any of the preceding aspects is provided, wherein the glass composition comprises an aluminosilicate glass composition.

In a tenth (10) aspect, the fining package according to any of the preceding aspects is provided, wherein the glass composition is used to form glass tubing.

In an eleventh (11) aspect, the fining package according to any of the preceding aspects is provided, wherein the glass tubing is used to form a pharmaceutical packaging.

In a twelfth (12) aspect, the fining package according to any of the preceding aspects is provided, wherein the pharmaceutical packaging comprises an ampoule.

In a thirteenth (13) aspect, the fining package according to any of the preceding aspects is provided, wherein the fining package comprises a fining viscosity at 1550° C. of less than 350 P.

In a fourteenth (14) aspect, the fining package according to any of the preceding aspects is provided, wherein the fining package is used to produce a glass article having a TL softening point of 760° C. to 782° C.

In a fifteenth (15) aspect, the fining package according to any of the preceding aspects is provided, wherein the fining package is used to produce a glass article having a coefficient of thermal expansion (CTE) of 50-59.10⁻⁷ K⁻¹.

In a sixteenth (16) aspect, the fining package according to any of the preceding aspects is provided, wherein the CTE is measured at 25° C. to 300° C.

In a seventeenth (17) aspect, a method of fining glass for forming pharmaceutical packaging is provided comprising: adding the fining package of aspect 1 to a glass composition to remove gas bubbles; and forming glass tubing from the fined glass composition.

In an eighteenth (18) aspect, a method according to aspect 17 is provided, further comprising forming a pharmaceutical packaging from the glass tubing.

In a nineteenth (19) aspect, a method according to aspect 18 is provided, wherein the pharmaceutical packaging comprises a pharmaceutical ampoule.

In a twentieth (20) aspect, a method according to any of aspects 17-19 is provided, wherein the glass composition may be a borosilicate glass composition.

In a twenty-first (21) aspect, a method according to any of aspects 17-19 is provided, wherein the glass composition may be an aluminosilicate glass composition.

Additional aspects of the present disclosure will be set forth, in part, in the detailed description, figures and any claims which follow, and in part will be derived from the detailed description, or can be learned by practice of the disclosure. It is to be understood that both the foregoing general description and the following detailed description are exemplary and explanatory only and are not restrictive of the disclosure as disclosed.

### BRIEF DESCRIPTION OF THE DRAWINGS

FIG. 1 is a comparison chart of photos of glass samples D4, D5, D6, D7, D8, and E9 formed as described in the present disclosure.

FIG. 2 is a comparison chart of photos of glass samples D10, D11, E12, E13, C2, and C3 formed as described in the present disclosure.

FIG. 3 is a comparison chart of photos of glass samples D14, D15, D16, and C4 formed as described in the present disclosure.

FIG. 4 is a comparison chart of photos of glass samples D17, D18, D19, D20, C5, C6, and D21 formed as described in the present disclosure.

### DETAILED DESCRIPTION

Various aspects of the disclosure will be described in detail with reference to drawings, if any. Reference to various aspects does not limit the scope of the invention, which is limited only by the scope of the claims attached hereto. Additionally, any examples set forth in this specification are not limiting and merely set forth some of the many possible aspects of the claimed invention.

Aspects described herein provide a simple, low-cost fining package that is fluorine-free and has a lower SnO₂ level compared to conventional fining packages for glass tubing formulated for closed ampoules. Methods described herein relate to fining of borosilicate glasses for glass tubing applications for use as pharmaceutical primary packaging. The typical fining agent for such borosilicate glasses is sodium chloride (NaCl), which is particularly efficient for the borosilicate glasses. However, for glass tubing to be used as closed ampoule pharmaceutical packaging, the glass needs to contain a level of chloride (Cl) that is low enough to meet European Pharmacopoeia (EP) requirements. Per edition 10.4 of the European Pharmacopoeia, the test for chlorides for sterilized water for injections is a maximum 0.5 ppm for containers with a nominal volume of 100 mL or less. Therefore, when ampoules contain water for injection, the EP requirements allow for a maximum of 0.5 ppm Cl for containers having a nominal volume lower than 100 mL. Therefore, if NaCl is used as the fining agent for a borosilicate glass such as Corning 51-D borosilicate glass tubing (Corning Incorporated, Corning, N.Y.), the batched Cl level is limited to 0.03 wt %.

To address fining of borosilicate glasses with a low chloride (Cl) content, conventional fining techniques use fining agents such as As₂O₃, Sb₂O₃, F, CeO₂, or SnO₂. However, when fining glass for pharmaceutical applications, As₂O₃ and Sb₂O₃ are typically avoided. As such, the conventional fining package used for borosilicate glass to be used for pharmaceutical applications, such as the Corning 51-D borosilicate glass tubing (Corning Incorporated, Corning, N.Y.), is complex and includes four fining agents. The four fining agents in the conventional fining package may include SnO₂, CeO₂, F, and Cl. Despite the complexity, the fining quality is significantly lower compared to borosilicate glass fined with NaCl.

However, such a fining package is complex, requiring several raw materials, which leads to increased expenses when compared to NaCl as a fining agent. For example, SnO₂ comes from an expensive raw material. As such, a need exists for a simpler, lower-cost fining package for use with pharmaceutical applications which maintains the fining performance achieved by the conventional fining package and also achieves the glass and product properties necessary for pharmaceutical applications.

In aspects, a simple, low-cost fining package is provided. The fining package may be used for fining of glass. Aspects of the fining package described herein may be used with glass compositions. In an aspect, the glass composition comprises a borosilicate glass composition. In an aspect, the glass composition comprises an aluminosilicate glass composition.

In an aspect, glass compositions using fining packages as described herein may be used to form glass tubing. In an aspect, the glass tubing formed from glass compositions that use fining packages as described herein may be used for pharmaceutical packaging. In an aspect, the pharmaceutical packaging may comprise ampoules. A nonlimiting example of clear borosilicate glass tubing formulated for closed ampoules is Corning 51-D borosilicate glass tubing (Corning Incorporated, Corning, N.Y.).

Nonlimiting examples of glass compositions are described in U.S. Patent Application Publication No. 2014/0001076, U.S. Patent Application Publication No. 2014/0001143, U.S. Patent Application Publication No. 2014/0151320, U.S. Patent Application Publication No. 2014/0151321, U.S. Patent Application Publication No. 2014/0151370, U.S. Pat. Nos. 9,034,442, and 9,428,302, each of which are hereby incorporated by reference in its entirety.

Aspects as described herein provide a fining package including at least two components. As a nonlimiting example, the fining package may comprise cerium dioxide (CeO₂) and tin oxide (SnO₂). In aspects, the fining package includes at least three components. As a nonlimiting example, the fining package may comprise cerium dioxide (CeO₂), tin oxide (SnO₂), and chloride (Cl). The fining package does not include fluorine (F).

Aspects as described herein provide a fining package comprising a low SnO₂ amount, compared to conventional fining packages. For example, a low amount of SnO₂ may be considered an amount less than about 0.3 wt %.

A simple fining package with fewer components is beneficial for batch mixing. For example, it is advantageous to have fewer raw materials to store and weigh before mixing, preparation, and introduction into the industrial production tank. Therefore, a fining package that allows for a F-free batch is beneficial. Such a glass composition allows for cost savings on the raw materials. The simplification of the fining package also allows for further development and a mechanistic understanding of the remaining fining agents.

Aspects described herein provide a simpler fining package than the conventional fining package used for borosilicate glass, due to the fining package described herein being fluorine free (F-free). The fining package described herein also has a lower cost than the conventional fining package used for borosilicate glass, due to a lower amount of SnO₂ needed for the fining package described herein. Moreover, the fining package described herein provides a fining performance that is the same as the conventional fining package used for borosilicate glass in term of seeds number at a lab scale. When compared to glass formed with the conventional fining package used for borosilicate glass, glass formed with the fining package described herein provides similar properties in term of high temperature viscosity, liquidus, softening point TL, CTE, density, refractive index, chemical resistance, and transmission.

A glass composition range is provided, as shown in Table 1, wherein the glass composition is fined with a simple, low-cost fining package compared to conventional fining packages. Table 1 shows glass compositions according to aspects described herein, including ranges of said glass compositions and properties of said glass compositions.

TABLE 1
Glass composition range and properties

| | Components | | | |
|---|---|---|---|---|
| | (analyzed wt %) | Range A | Range B | Range C |
| Glass | SiO₂ | 70-76 | 70-74 | 70-73 |
| Composition | B₂O₃ | 9-13.5 | 10-13.5 | 10.5-13.2 |
| | Al₂O₃ | 4-8 | 5-7 | 5-7 |
| | TiO₂ | 0-0.1 | 0-0.03 | 0-0.03 |
| | Fe₂O₃ | 0-0.1 | 0-0.04 | 0-0.04 |
| | BaO | 0-0.1 | 0-0.04 | 0-0.04 |
| | CaO | 0-3 | 0.5-2.3 | 1-2.3 |
| | Na₂O | 5-8.5 | 6.5-7.5 | 6.5-7.3 |
| | K₂O | 0.5-3 | 1.0-1.8 | 1.0-1.5 |
| | MgO | 0-1 | 0-0.1 | 0-0.1 |
| | Cl | 0-0.03 | 0.01-0.03 | 0.01-0.02 |
| | F | 0-0.02 | 0-0.02 | 0-0.02 |
| | CeO₂ | 0.08-0.5 | 0.08-0.2 | 0.08-0.2 |
| | SnO₂ | 0.02-0.23 | 0.02-0.12 | 0.02-0.12 |
| | ZrO₂ | 0-0.08 | 0-0.08 | 0-0.08 |
| Properties | working point | 1130-1170 | 1130-1170 | 1130-1170 |
| | T(10⁴ P) (° C.) | | | |
| | forming viscosity | 1100-1500 | 1100-1500 | 1100-1500 |
| | at 1350° C. (P) | | | |
| | fining viscosity | <350 | <350 | <350 |
| | at 1550° C. (P) | | | |
| | liquidus (° C.) | <1000 | <1000 | <1000 |
| | TL softening point | 760-782 | 760-777 | 764-777 |
| | (° C.) | | | |
| | CTE (25-300° C.) | 50-59 | 52-54 | 52-54 |
| | (.10⁻⁷ K⁻¹) | | | |
| | Density | 2.31-2.38 | 2.32-2.36 | 2.32-2.36 |
| | refractive index | 1.48-1.50 | 1.48-1.50 | 1.48-1.50 |
| | n_{D} (at 589 nm) | | | |
| | DIN 12116 | <1.5 | <1.5 | <1.5 |
| | (mg/dm²) | | | |
| | ISO 695 (mg/dm²) | <150 | <150 | <150 |
| | ISO 720 | <0.065 | <0.065 | <0.065 |
| | (mL HCl/g glass) | | | |
| | EP. 9.4 (3.2.1B) | <0.065 | <0.060 | <0.060 |
| | (mL HCl/g glass) | | | |
| | Y (D65) (%) | 90-95 | 90-95 | 90-95 |
| | (under 1 mm) | | | |
| | haze (%) | <1 | <1 | <1 |

### EXPERIMENTAL RESULTS

Glass Preparation, Seeds Counting and Solids Analysis

Glass samples were prepared using two methods based on two lab melting tools. Method 1 used an electrical furnace. Method 2 used a gas-air furnace; the use of a gas-air furnace aims to reproduce melting under similar atmosphere than in a conventional melting tank used for borosilicate glass.

For Method 1, an appropriate amount of raw materials to obtain 1000 g of glass was set in 4 pur platinum crucibles and melted in an electrical furnace heated by Globar® heating elements. Two types of melting cycles were used: Cycle A and Cycle B.

Cycle A was used to assess the fining efficiency of fining packages and is associated with sample preparation methods 1.1 and 1.2. For Cycle A, the crucibles were introduced in the furnace preheated at 1450° C.; held for 1 hour at 1450° C.; heated 120-150 minutes from 1450° C. to 1550° C.; held at 1550° C. during a dwell time (labeled “D”); and the crucibles were pulled out at 1550° C.

In sample preparation and seeds counting method 1.1, after Cycle A, the glasses were rolled into a plate and annealed for 1 hour at 600° C. In each plate, samples were core-drilled and polished. The seeds were counted in each sample and the number was normalized by the involved glass volume (about 2.4 cm³). The average normalized seeds number was calculated for each plate and reported as the “seeds average (number/cm³)” in Table 2. A lower “seeds average” value corresponded to a better fining efficiency of the fining package.

In sample preparation and seeds counting method 1.2, after Cycle A, the glasses were annealed in the crucibles for 2 hours at 600° C. Samples were core drilled from glass in the crucibles. In each sample, one vertical slice was taken from the center and polished. Seeds were counted at three distances from the glass surface: 0 mm, 25 mm, and 50 mm into a specific area. The seeds numbers were normalized by the analyzed glass volume (about 0.7-0.8 cm³). For each counting, the geometric dimensions of analyzed glass volume were measured. The sum of the normalized seeds numbers at 0 mm, 25 mm, and 50 mm from the glass surface was calculated for each sample and reported as “sum seeds/cm³” in Table 8 and Table 12.

Cycle B was used to measure the glass properties on fully melted and fined samples. For Cycle B, the crucibles were introduced into the furnace preheated at 1450° C.; held for 1 hour at 1450° C.; heated 150 minutes from 1450° C. to 1550° C.; held at 1550° C. for 3-4 hours; and the crucibles were pulled out at 1550° C. After melting, the glasses were rolled into a plate and annealed for 1 hour at 600° C. The sample preparation was made according to the measured property. The crucibles were cooled in cold water, and the remaining glass in the crucibles was extracted, dried, and used as cullet for the high temperature viscosity measurements.

For Method 2, 1000 g of raw materials was set in platinum crucibles and melted in a gas-air furnace. For the melting cycle, the crucibles were introduced into the furnace preheated at 1450° C.; held for 1 hour at 1450° C.; heated 10-15 minutes from 1450° C. to 1550° C.; held at 1550° C. for 1 hour; and the crucibles were pulled out at 1550° C. After melting, the glasses were annealed in the crucibles at 600° C. Samples were core drilled from the crucible, and a vertical slice was taken from the center of each sample and polished. Seeds were counted at 3 distances from the glass surface: 0 mm, 25 mm, and 50 mm. The seeds numbers were normalized by the involved glass volume (about 0.5-0.6 cm³). The sum of the normalized numbers at 0 mm, 25 mm, and 50 mm from the glass surface was calculated for each sample and reported as “seeds sum” in Table 3, Table 4, Table 5, Table 6, and Table 7. In the glass slice, the solids were identified, the size was measured, and the volume was calculated. Table 3, Table 4, and Table 5 report the sum of the volumes of solids.

Due to observed experimental variability between each melt, the results are reported for one melt at a time for both Method 1 and Method 2.

Characterizations of Glass Composition and Properties

The glass composition was analyzed by XRF on samples. The XRF data were collected on a Panalytical Axios spectrometer and analyzed with a proprietary quantitative program. The SiO₂ percentage was calculated by subtraction of the sum of all other oxides and elements from 100. The glass composition was reported in weight percent (wt %) based on oxides and on elements for Cl and F.

The high-temperature viscosity was measured from cullet using a rotational viscosimeter (Gero) from low viscosity to high viscosity. The Vogel-Fulcher-Tammann equation was fitted to the experimental data and used to calculate the working point corresponding to the temperature at which the viscosity of the glass is 10⁴ P; the forming viscosity at 1350° C.; and the fining viscosity at 1550° C.

The softening point (TL) was measured with a parallel plate viscometer (PPV) and corresponds to the temperature where the glass viscosity is 10^{7.6} P.

The liquidus was given by a range of temperature where the highest temperature corresponds to the minimum temperature at which no crystal was observed, and the lowest temperature corresponds to the maximum temperature at which crystals were observed. The devitrification characteristics (low and high liquidus temperatures) were determined as follows. Glass samples (12 mm diameter, 4 mm thick) were subjected to the following thermal treatment using pur Pt open sample holder: placing in a furnace preheated to 1050° C.; maintaining that temperature for 30 min; lowering to the test temperature, T, at a rate of 10° C./min; maintaining that temperature T for 17 hr; and quenching the samples. The crystals present, if any, were observed with a polarizing microscope in transmitted light. The primary phase was identified from the crystal shape and was assigned to cristobalite (SiO₂) for these borosilicate glasses.

The coefficient of thermal expansion (CTE) was measured between 25° C. and 300° C. with a high temperature dilatometer at a heating rate of 5° C./min. The samples were small rods of glass (6×6×50 mm). The density was measured on glass samples with an He pycnometer at room temperature (Accupyc II 1340).

Visible-IR transmission and diffusion measurements were performed on a 1 mm thick sample with a Varian spectrophotometer (Cary 500 Scan model). Visible transmission and diffusion measurements were carried out with an integrating sphere. On the basis of the visible transmission and diffusion measurements, the integrated transmission (Y (%)) in the visible range (between 380 and 780 nm) and the haze (%) were calculated using the standard ASTM D 1003-13 (under D65 illuminant with a 2° observer). The colorimetric parameters were represented in the CIE L*a*b* color space, under D65 illuminant with a 2° observer.

The water content was estimated from the β-OH value calculated from IR transmission. The β-OH was calculated using the following equation:

β-OH (mm⁻¹)=log (T(2600)/Tₘᵢₙ(2800))/e

with:
T(2600): transmission at 2600 nm (%);
Tₘᵢₙ(2800): lowest transmission in the vicinity of 2800 nm (%); and
e: sample thickness (1 mm)

The refractive index at 589 nm was measured on the Metricon device on a 2 mm thick glass sample.

The hydrolytic resistance of glass was evaluated according to the ISO 720:2020(E) standard and European Pharmacopoeia (Ph.Eur.) 9.4, Chapter 3.2.1, Test B: Glass Grains Test.

The acid resistance was measured according to the DIN 12116 standard, and the alkali resistance was measured according to ISO 695 standard.

Results

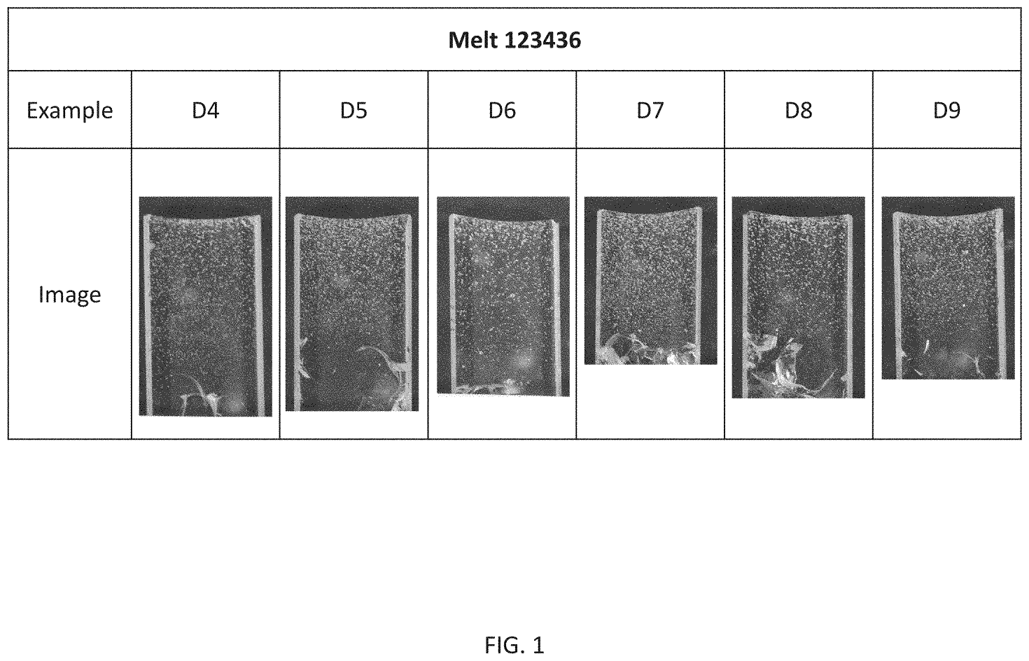

In FIGS. 1-4 and Tables 2-12, examples D1, D2, D4 to D9, D10, D11, D14 to D22, D24, D26, D28, D30 to D33, D48, D49 contain a fluorine (F) level higher than 0.02 wt % and may be used as comparative examples for conventional melting tank borosilicate glass fining packages and compositions.

Conventional Borosilicate Glass Tank Fining Package

The role of each main component of a conventional fining package was analyzed regarding the effect that each component has with respect to fining. In melt F5484, Method 1 was used with melting cycle A (D equals to 1 hour) and sample preparation method 1.1. Example D1 provides a comparative example of a conventional melting tank borosilicate glass composition fining package. The analyzed glass composition and seeds counting results are reported in Table 2. The SnO₂ removal (E2) or the F removal (E3) lead to similar number of seeds than the conventional fining package (40-250 seeds/cm³) whereas the CeO₂ removal leads to a significantly higher number of seeds (>2500 seeds/cm³) so fining is mostly driven by CeO₂ in this fining package.

Table 2 shows D1, D2, E3, and C1 and the fining study of main components of the conventional fining package in melt F5484: the fining performance is mostly driven by CeO₂ in this fining package.

TABLE 2
Fining Packages and Compositions for D1, D2, E3, and C1

| Example | D1 | D2 | E3 | C1 |
|---|---|---|---|---|
| SiO₂ | 73.02 | 73.07 | 72.68 | 73.77 |
| B₂O₃ | 10.60 | 10.62 | 10.92 | 10.18 |
| Al₂O₃ | 6.58 | 6.59 | 6.50 | 6.60 |
| TiO₂ | 0.01 | 0.01 | 0.01 | 0.01 |
| Fe₂O₃ | 0.005 | 0.005 | 0.005 | 0.007 |
| BaO | 0.003 | 0.006 | 0.003 | 0.012 |
| CaO | 1.33 | 1.34 | 1.31 | 1.34 |
| Na₂O | 6.72 | 6.78 | 7.02 | 6.55 |
| K2O | 1.11 | 1.12 | 1.11 | 1.12 |
| MgO | 0.02 | 0.02 | 0.03 | 0.02 |
| Cl | 0.02 | 0.02 | 0.02 | 0.02 |
| F | 0.19 | 0.20 | 0.002 | 0.18 |
| CeO₂ | 0.20 | 0.21 | 0.20 | 0 |
| SnO₂ | 0.19 | 0.01 | 0.19 | 0.19 |
| seeds average | 137 | 224 | 45 | 2590 |
| (number/cm³) | | | | |

SnO₂ and CeO₂ Levels

Variations of SnO₂ and CeO₂ levels were carried out using Method 2 in melts 123436 and 123820. Conventional melting tank borosilicate glass compositions and fining packages are provided by comparative examples D8 and D10. In melt 123820, halides-free and/or SnO₂-free fining packages were also investigated. Table 3, Table 4, and Table 5 report the analyzed glass composition, the slice sample pictures, seeds counting, and solids results.

Table 3 shows Melt 123436 and examples D4, D5, D6, D7, D8, and D9. Example D8 provides a nonlimiting example of a conventional fining package, and the other examples start out with the levels of the D8 conventional fining package and provide further variation of SnO₂ and CeO₂ levels. As shown by Table 3, the fining performances are similar for any investigated SnO₂ and CeO₂ levels. FIG. 1 shows a comparison of samples from melt 123436 wherein the comparison chart shows images of examples D4, D5, D6, D7, D8, and D9.

TABLE 3
Fining Packages and Compositions for Melt 123436 and D4 to D9

| Example | D4 | D5 | D6 | D7 | D8 | D9 |
|---|---|---|---|---|---|---|
| SiO₂ | 71.95 | 72.43 | 72.26 | 73.08 | 73.02 | 73.42 |
| B₂O₃ | 11.46 | 11.19 | 11.31 | 10.51 | 10.55 | 10.53 |
| Al₂O₃ | 6.57 | 6.64 | 6.53 | 6.68 | 6.59 | 6.48 |
| TiO₂ | 0.01 | 0.01 | 0.01 | 0.01 | 0.01 | 0.01 |
| Fe₂O₃ | 0.002 | 0.003 | 0.004 | 0.004 | 0.004 | 0.004 |
| BaO | 0.02 | 0.02 | 0.00 | 0.03 | 0.02 | 0.02 |
| CaO | 1.35 | 1.36 | 1.34 | 1.37 | 1.36 | 1.34 |
| Na₂O | 6.82 | 6.61 | 6.84 | 6.56 | 6.70 | 6.48 |
| K₂O | 1.13 | 1.14 | 1.13 | 1.15 | 1.14 | 1.12 |
| MgO | 0.03 | 0.03 | 0.03 | 0.03 | 0.03 | 0.03 |
| Cl | 0.017 | 0.016 | 0.015 | 0.015 | 0.018 | 0.015 |
| F | 0.21 | 0.19 | 0.19 | 0.20 | 0.20 | 0.19 |
| CeO₂ | 0.41 | 0.30 | 0.24 | 0.20 | 0.18 | 0.17 |
| SnO₂ | 0.03 | 0.06 | 0.10 | 0.17 | 0.18 | 0.19 |
| seeds sum | 480 | 466 | 201 | 601 | 208 | 641 |
| (number/cm³) | | | | | | |
| solids volume | 0 | 0.43 | 0.88 | 0 | 0.50 | 0.64 |
| (mm³) | | | | | | |

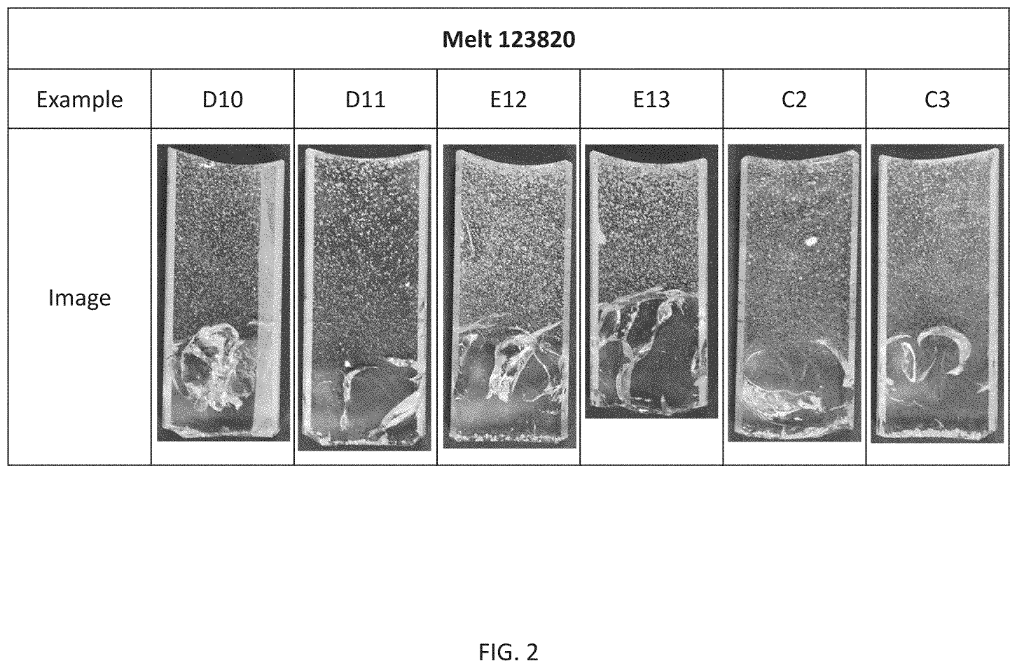

Table 4 shows Melt 123820 and examples D10, D11, E12, and E13. D11 shows variations of SnO₂ and CeO₂ levels, with results showing that the fining performances are similar for any investigated SnO₂ and CeO₂ levels. E12 and E13 show halides-free fining packages, with results showing no change in fining with CeO₂ and SnO₂ levels close to conventional fining package levels. FIG. 2 shows a comparison of samples from melt 123820 wherein the comparison chart shows images of examples D10, D11, E12, and E13 as well as comparative examples C2 and C3.

TABLE 4
Fining Packages and Compositions for Melt
123820 and D10, D11, E12, and E13

| Example | D10 | D11 | E12 | E13 |
|---|---|---|---|---|
| SiO₂ | 73.05 | 72.99 | 73.31 | 73.69 |
| B₂O₃ | 10.58 | 10.64 | 10.46 | 10.14 |
| Al₂O₃ | 6.64 | 6.57 | 6.75 | 6.73 |
| TiO₂ | 0.01 | 0.01 | 0.01 | 0.01 |
| Fe₂O₃ | 0.004 | 0.004 | 0.003 | 0.003 |
| BaO | 0.03 | 0.03 | 0.02 | 0.02 |
| CaO | 1.37 | 1.35 | 1.39 | 1.39 |
| Na₂O | 6.59 | 6.71 | 6.42 | 6.40 |
| K2O | 1.15 | 1.13 | 1.16 | 1.16 |
| MgO | 0.02 | 0.03 | 0.04 | 0.04 |
| Cl | 0.017 | 0.016 | 0.018 | 0.006 |
| F | 0.18 | 0.19 | 0.01 | 0.01 |
| CeO₂ | 0.19 | 0.14 | 0.22 | 0.22 |
| SnO₂ | 0.18 | 0.20 | 0.18 | 0.19 |
| seeds sum | 1011 | 671 | 1546 | 1228 |
| (number/cm³) | | | | |
| solids volume | 4.02 | 4.28 | 0 | 1.4 |
| (mm³) | | | | |

Containing F and Cl levels close to the conventional fining package levels, wherein the F level is between 0.18 and 0.21 wt % and the Cl level is between 0.015 and 0.018 wt %, examples D4 to D11 show similar seeds sum (200-1100 seeds/cm³) and limited solids volume (<4.3 mm³) for the different SnO₂ and CeO₂ levels.

With CeO₂ and SnO₂ close to conventional fining package levels, but without batched F, or without batched F and Cl, examples E12 and E13 show similar seeds sum (1200-1600 seeds/cm³) and low solids volume (<1.5 mm³).

Table 5 shows comparative examples C2 and C3 from Melt 123820. The comparative examples provide a study of variations of SnO₂ and CeO₂ levels in a conventional fining package, wherein a minimum value of CeO₂ is required to limit seeds number and a maximum value of SnO₂ is identified due to solids. Furthermore, the comparative examples provide a study of a fining package including only CeO₂. Minimum values of Cl or SnO₂ are required to limit the seeds number.

TABLE 5
Fining Packages and Compositions of Comparative
Examples C2 and C3 from Melt 123820

| Comparative example | C2 | C3 |
|---|---|---|
| SiO₂ | 72.90 | 74.02 |
| B₂O₃ | 10.67 | 9.88 |
| Al₂O₃ | 6.63 | 6.85 |
| TiO₂ | 0.01 | 0.01 |
| Fe₂O₃ | 0.005 | 0.004 |
| BaO | 0.03 | 0.03 |
| CaO | 1.36 | 1.42 |
| Na₂O | 6.72 | 6.31 |
| K2O | 1.14 | 1.18 |
| MgO | 0.03 | 0.04 |
| Cl | 0.016 | 0.006 |
| F | 0.19 | 0.02 |
| CeO₂ | 0.06 | 0.23 |
| SnO₂ | 0.25 | 0.01 |
| seeds sum | 2150 | 2429 |
| (number/cm³) | | |
| solids volume | 8.50 | 0 |
| (mm³) | | |

Comparative example C2 shows that a lower CeO₂ level (<0.06 wt %) and a larger SnO₂ level (>0.25 wt %) leads to a higher seeds number (>2000 seeds/cm³) as well as a larger solids volume (>8 mm³). Solids are visible in the C2 sample picture as white spots in FIG. 2. A minimum value of CeO₂ is required to limit seeds number and a maximum value of SnO₂ is identified due to solids.

Comparative example C3 shows that having only CeO₂ as a fining agent at 0.23 wt % leads to the highest seeds number (>2400 seeds/cm³). Minimum values of Cl or SnO₂ are required to limit the seeds number.

SnO₂ Reduction

Reduction of SnO₂ level was carried out to identify the impact on fining using Method 2 during melts 126438 and 127082. The advantage of reducing the level of SnO₂ relates to batch cost reduction, since SnO₂ comes from an expensive raw material. Results are reported in Table 6 and Table 7.

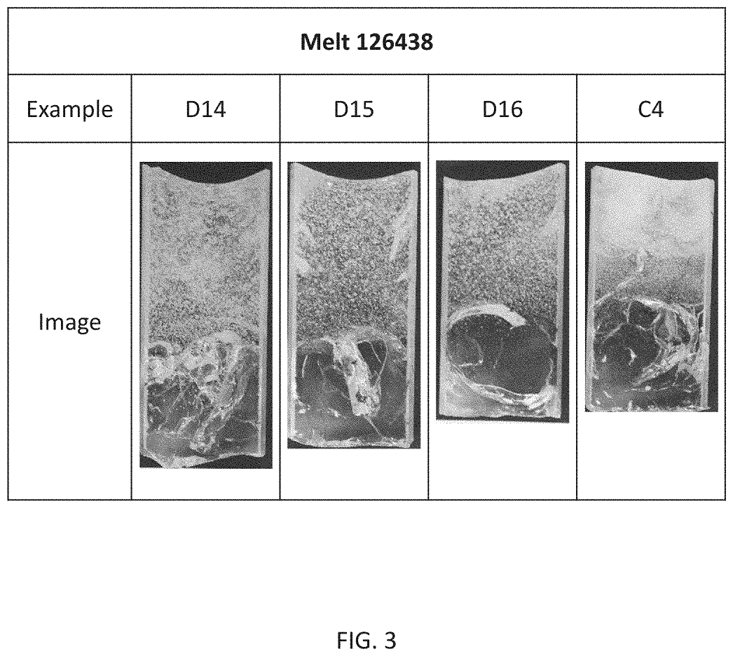

Table 6 shows Melt 126438 with various SnO₂ levels, with results showing similar fining performance for SnO₂ levels between 0.122 and 0.049 wt %. FIG. 3 shows a comparison of samples from melt 126438 wherein the comparison chart shows images of examples D14, D15, D16, and C4.

TABLE 6
Fining Packages and Compositions of Melt 126438 and
D14, D15, D16, and C4 with various SnO₂ levels

| Example | D14 | D15 | D16 | C4 |
|---|---|---|---|---|
| SiO₂ | 74.92 | 73.91 | 74.04 | 75.24 |
| B₂O₃ | 9.17 | 9.92 | 9.82 | 8.85 |
| Al₂O₃ | 6.78 | 6.70 | 6.78 | 7.05 |
| TiO₂ | 0.01 | 0.01 | 0.01 | 0.01 |
| Fe₂O₃ | 0.004 | 0.004 | 0.005 | 0.004 |
| BaO | 0.005 | 0.005 | 0.005 | 0.005 |
| CaO | 1.38 | 1.37 | 1.38 | 1.45 |
| Na₂O | 6.00 | 6.40 | 6.30 | 5.70 |
| K₂O | 1.17 | 1.16 | 1.16 | 1.22 |
| MgO | 0.02 | 0.02 | 0.02 | 0.02 |
| Cl | 0.02 | 0.02 | 0.02 | 0.02 |
| F | 0.20 | 0.20 | 0.21 | 0.22 |
| CeO₂ | 0.20 | 0.20 | 0.20 | 0.21 |
| SnO₂ | 0.122 | 0.080 | 0.049 | 0.006 |
| seeds sum | 1333 | 1736 | 1751 | — |
| (number/cm³) | | | | |

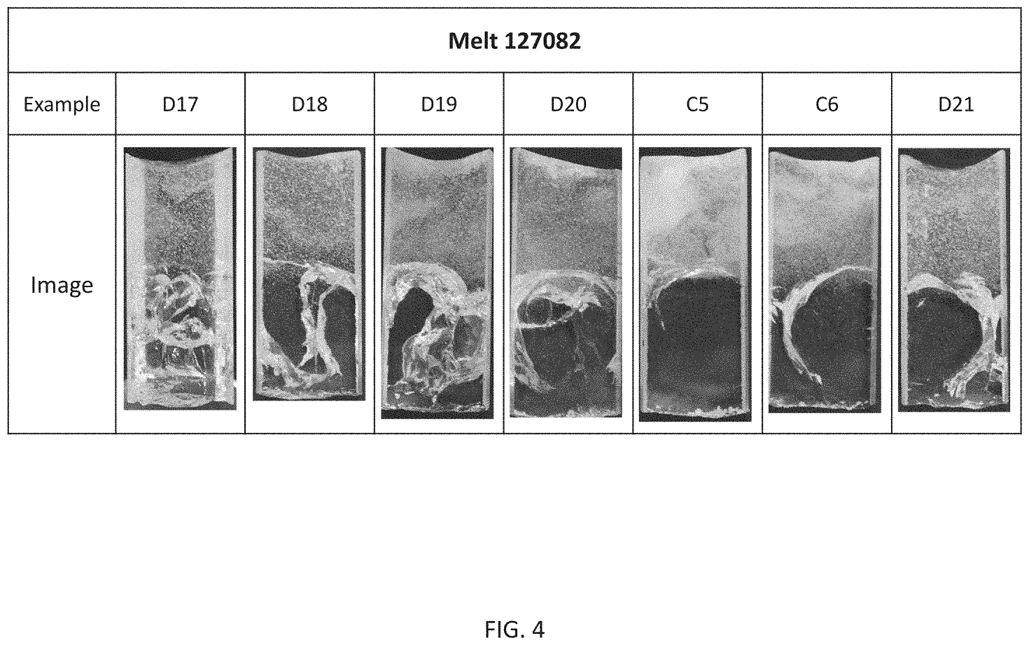

Table 7 shows Melt 127082 with various SnO₂ levels, with results showing similar fining performance for SnO₂ levels between 0.120 and 0.031 wt %. Melt 127082 also includes example E18 having no batched Cl, with results showing that there was no fining change observed without Cl in the conventional fining package. FIG. 4 shows a comparison of samples from melt 127082 wherein the comparison chart shows images of examples D17, D18, D19, D20, C5, C6, and D21.

TABLE 7
Fining Packages and Compositions of Melt 127082 and
D17-D21, C5, and C6 with various SnO₂ levels

| Example | D17 | D18 | D19 | D20 | C5 | C6 | D21 |
|---|---|---|---|---|---|---|---|
| SiO₂ | 74.25 | 74.20 | 74.57 | 74.20 | 74.69 | 73.76 | 74.61 |
| B₂O₃ | 9.75 | 9.78 | 9.45 | 9.69 | 9.30 | 10.16 | 9.33 |
| Al₂O₃ | 6.81 | 6.83 | 6.95 | 6.87 | 7.08 | 6.75 | 6.95 |
| TiO₂ | 0.01 | 0.01 | 0.01 | 0.01 | 0.01 | 0.01 | 0.01 |
| Fe₂O₃ | 0.004 | 0.004 | 0.004 | 0.004 | 0.004 | 0.004 | 0.004 |
| BaO | 0.003 | 0.003 | 0.004 | 0.002 | 0.010 | 0.004 | 0.003 |
| CaO | 1.40 | 1.41 | 1.42 | 1.41 | 1.45 | 1.39 | 1.42 |
| Na₂O | 6.06 | 6.05 | 5.91 | 6.17 | 5.71 | 6.31 | 5.92 |
| K₂O | 1.17 | 1.18 | 1.20 | 1.18 | 1.22 | 1.17 | 1.20 |
| MgO | 0.02 | 0.02 | 0.02 | 0.02 | 0.02 | 0.02 | 0.02 |
| Cl | 0.017 | 0.007 | 0.017 | 0.017 | 0.016 | 0.019 | 0.017 |
| F | 0.20 | 0.21 | 0.21 | 0.21 | 0.24 | 0.21 | 0.21 |
| CeO₂ | 0.19 | 0.18 | 0.19 | 0.19 | 0.23 | 0.19 | 0.19 |
| SnO₂ | 0.120 | 0.118 | 0.047 | 0.031 | 0.018 | 0.005 | 0.120 |
| seeds sum | 861 | 667 | 716 | 824 | — | — | 799 |
| (number/cm³) | | | | | | | |

Example E18 has no Cl batched and shows the same seeds counting as references D17 and D21 (660-870 seeds/cm³).

In both melts, a similar fining was observed for D14 to D21 having from 0.12 to 0.031 wt % SnO₂. The seeds sum was in the same order of magnitude as references D14 and D17 (1300-1800 seeds/cm³ for melt 126438 and 700-900 seeds/cm³ for melt 127082). However, a significant increase in small seeds was visible for the lowest SnO₂ levels of 0.018 and 0.005 wt % (C4-05-C6), and in those cases, the seeds were so numerous that they were not counted.

The results of the experimental study indicated that a lower cost fining package may be provided than the conventional fining package.

F Removal

Examples E3 and E12 did not include batched F and showed similar seeds numbers as references D1 and D10, respectively. Accordingly, the fining package may be further simplified by removing F.

Fining without F

To study fining packages that remove F, lower SnO₂ and CeO₂ levels in the composition were studied. Levels of SnO₂ around 0.1 wt % and levels of CeO₂ around 0.15 wt % were studied using Method 1, melting Cycle A, and sample preparation method 1.2 (melts F5521 and F5522). Results are provided in Table 8.

Table 8 shows seeds counting for various dwell fining time (D) for reference compositions and for F-free compositions, with results showing that the F-free fining package had the same fining efficiency as the fining package including F.

TABLE 8
Fining Packages and Compositions and Seeds counting for various dwell fining
time (D) for D22, E23, D24, E25, D26, E27, D28, and E29

| Example | D22 | E23 | D24 | E25 | D26 | E27 | D28 | E29 |
|---|---|---|---|---|---|---|---|---|
| Melt ID | F5521 | F5522 | F5521 | F5522 | F5521 | F5522 | F5521 | F5522 |
| Reference FSP | 56 | 57 | 56 | 57 | 56 | 57 | 56 | 57 |
| (analyzed wt %) | | | | | | | | |
| SiO₂ | 72.64 | 73.07 | 72.75 | 72.81 | 72.29 | 72.75 | 72.59 | 72.58 |
| B₂O₃ | 11.14 | 10.84 | 10.99 | 11.01 | 11.3 | 11.04 | 11.09 | 11.16 |
| Al₂O₃ | 6.43 | 6.48 | 6.52 | 6.48 | 6.51 | 6.51 | 6.48 | 6.51 |
| TiO₂ | 0.01 | 0.01 | 0.01 | 0.01 | 0.01 | 0.01 | 0.01 | 0.01 |
| Fe₂O₃ | 0.006 | 0.005 | 0.005 | 0.005 | 0.006 | 0.005 | 0.006 | 0.005 |
| BaO | 0.006 | 0.01 | 0.007 | 0.011 | 0.007 | 0.01 | 0.007 | 0.009 |
| CaO | 1.30 | 1.31 | 1.32 | 1.31 | 1.33 | 1.31 | 1.31 | 1.33 |
| Na₂O | 6.92 | 6.86 | 6.84 | 6.94 | 6.98 | 6.95 | 6.97 | 6.97 |
| K₂O | 1.1 | 1.11 | 1.12 | 1.11 | 1.12 | 1.12 | 1.11 | 1.13 |
| MgO | 0.02 | 0.02 | 0.02 | 0.02 | 0.02 | 0.02 | 0.02 | 0.02 |
| Cl | 0.02 | 0.02 | 0.02 | 0.02 | 0.02 | 0.02 | 0.02 | 0.03 |
| F | 0.17 | 0.01 | 0.16 | 0.01 | 0.17 | 0 | 0.16 | 0 |
| CeO₂ | 0.14 | 0.15 | 0.14 | 0.16 | 0.14 | 0.15 | 0.13 | 0.15 |
| SnO₂ | 0.1 | 0.11 | 0.1 | 0.1 | 0.1 | 0.11 | 0.1 | 0.1 |
| D (min) | 0 | | 30 | | 60 | | 90 | |
| sum seeds/cm³ | 1130 | 1161 | 437 | 285 | 25 | 55 | 17 | 7 |

At each dwell fining time (D) from 0 minute to 90 minutes, the seeds counting was similar for the reference compositions (D22, D24, D26, and D28) and for the F-free compositions (E23, E25, E27, and E29). As such, results showed that the F-free fining package had the same fining efficiency as the reference fining package.

There is an interest to have a simpler, lower cost fining package that maintains the fining performance as well as the glass and product properties. Removing F allows for simplification of the fining package. However, F is well known to reduce the viscosity of the melt. Though removing F may allow for simplification of the fining package, the stability of the softening point as well as of the critical glass and product properties is required.

Glass Properties without Fluorine (F)

Glass samples were prepared by Method 1 with melting Cycle B. Examples D30 to D33 correspond to a reference composition (FSP 56) and examples E43 and E44 correspond to a reference composition without F (FSP 57). As expected, the F removal generated an increase of the softening point of about 6° C. (see comparison of examples D30 and E43).

To compensate for the F removal, glass compositions added Na₂O, B₂O₃, CaO, and K₂O and combined additions of Na₂O and B₂O₃. The appropriate additions of B₂O₃ or of Na₂O and B₂O₃ allow for compositional changes that compensate for the softening point increase while keeping the glass properties (CTE, density, hydrolytic resistance) close to the reference values.

The glass compositions and properties for examples and comparatives examples are reported in Table 9, Table 10, and Table 11. Examples in Table 9 have both CTE and TL values in the target ranges of CTE between 52-54.10⁻⁷ K⁻¹ (25-300° C.) and TL between 764-777° C.

Because comparative example C7 has a high B₂O₃ level, the TL is too low (758.7° C.). Because comparative example C8 has a high K₂O level, the CTE and density are too large (63.6.10⁻⁷ K⁻¹ and 2.39, respectively). Because comparative example C9 has a high CaO level, the hydrolytic resistance is damaged according to the EP. 9.4 (3.2.1 B) test (0.069 mL HCl/g glass).

Table 9 shows glass compositions and properties for reference compositions D30, D31, D32, and D33.

TABLE 9
Fining Packages and Glass Compositions and Properties for D30-D33

| Example | D30 | D31 | D32 | D33 |
|---|---|---|---|---|
| Melt ID | F5523 | F5534 | F5537 | F5539 |
| Reference FSP | 56-2 | 56 | 56 | 56 |
| (analyzed wt %) | | | | |
| SiO₂ | 72.921 | 72.547 | 72.575 | 72.105 |
| B₂O₃ | 10.87 | 11.12 | 11.01 | 11.48 |
| Al₂O₃ | 6.50 | 6.50 | 6.57 | 6.47 |
| TiO₂ | 0.01 | 0.01 | 0.01 | 0.01 |
| Fe₂O₃ | 0.006 | 0.006 | 0.005 | 0.005 |
| BaO | 0.003 | 0.009 | 0.004 | 0.003 |
| CaO | 1.31 | 1.32 | 1.33 | 1.32 |
| Na₂O | 6.88 | 6.94 | 6.93 | 7.08 |
| K₂O | 1.09 | 1.11 | 1.12 | 1.12 |
| MgO | 0.02 | 0.01 | 0.02 | 0.02 |
| Cl | 0.020 | 0.019 | 0.017 | 0.016 |
| F | 0.140 | 0.154 | 0.160 | 0.151 |
| CeO₂ | 0.13 | 0.15 | 0.14 | 0.12 |
| SnO₂ | 0.100 | 0.105 | 0.110 | 0.098 |
| working point T(10⁴ P) (° C.) | 1160 | 1155 | 1155 | |
| forming viscosity at 1350° C. (P) | 1402 | 1351 | 1339 | |
| fining viscosity at 1550° C. (P) | 314 | 311 | 304 | |
| liquidus (° C.) | — | 942-957 | — | |
| TL softening point (° C.) | 775.7 | 767.3 | 767 | 770.4 |
| β-OH (mm⁻¹) | 0.68 | 0.74 | 0.68 | 0.61 |
| CTE (25-300° C.) (.10⁻⁷ K⁻¹) | 52.5 | 53.0 | 52.5 | 52.5 |
| density | 2.340 | 2.340 | 2.341 | 2.340 |
| refractive index n_{D} (589 nm) | 1.48985 | — | — | |
| DIN 12116 (mg/dm²) | 0.54 | — | — | |
| Class | S1 | — | — | |
| ISO 695 (mg/dm²) | 115.7 | — | — | |
| Class | A2 | — | — | |
| ISO 720 (ml HCl/g glass) | — | — | 0.047 | |
| Class | — | — | HGA 1 | |
| EP. 9.4 (3.2.1 B) (ml HCl/g glass) | — | 0.046 | — | 0.049 |
| Class | — | Type I | — | Type I |
| Y (D65) (%) (1 mm) | — | — | 92.30 | |
| L* | — | — | 96.9437 | |
| a* | — | — | 0.0200 | |
| b* | — | — | 0.1452 | |
| haze (%) | — | — | 0.49 | |

Table 10 shows glass compositions and properties for E34, E35, E36, E37, E38, E39, E40, E41, and E42, which are F-free examples having CTE and TL values in the target ranges.

TABLE 10
Fining Packages and Glass Compositions and Properties for E34-E42

| Example | E34 | E35 | E36 | E37 | E38 | E39 | E40 | E41 | E42 |
|---|---|---|---|---|---|---|---|---|---|
| Melt ID | F5527 | F5534 | F5537 | F5537 | F5525 | F5534 | F5528 | F5539 | F5539 |
| Reference FSP | 62 | 74 | 74-1 | 74-2 | 60 | 72 | 66 | 75 | 76 |
| (analyzed wt %) | | | | | | | | | |
| SiO₂ | 70.951 | 71.999 | 71.874 | 72.162 | 71.687 | 72.082 | 71.819 | 72.144 | 72.140 |
| B₂O₃ | 13.03 | 11.77 | 11.73 | 11.59 | 11.89 | 11.80 | 11.24 | 11.68 | 11.72 |
| Al₂O₃ | 6.50 | 6.47 | 6.53 | 6.52 | 6.50 | 6.49 | 6.45 | 6.47 | 6.40 |
| TiO₂ | 0.01 | 0.01 | 0.01 | 0.01 | 0.01 | 0.01 | 0.01 | 0.01 | 0.01 |
| Fe₂O₃ | 0.005 | 0.005 | 0.005 | 0.006 | 0.006 | 0.005 | 0.005 | 0.005 | 0.004 |
| BaO | 0.003 | 0.009 | 0.004 | 0.005 | 0.004 | 0.009 | 0.004 | 0.003 | 0.003 |
| CaO | 1.34 | 1.31 | 1.32 | 1.33 | 1.32 | 1.31 | 2.19 | 1.31 | 1.30 |
| Na₂O | 6.80 | 7.02 | 7.12 | 7.00 | 7.22 | 6.88 | 6.90 | 7.01 | 7.05 |
| K₂O | 1.09 | 1.11 | 1.12 | 1.09 | 1.10 | 1.12 | 1.10 | 1.10 | 1.10 |
| MgO | 0.02 | 0.02 | 0.03 | 0.03 | 0.02 | 0.02 | 0.04 | 0.02 | 0.02 |
| Cl | 0.016 | 0.018 | 0.018 | 0.018 | 0.016 | 0.017 | 0.018 | 0.017 | 0.018 |
| F | 0 | 0 | 0 | 0 | 0 | 0 | 0 | 0 | 0.003 |
| CeO₂ | 0.13 | 0.15 | 0.14 | 0.14 | 0.13 | 0.15 | 0.13 | 0.13 | 0.13 |
| SnO₂ | 0.103 | 0.106 | 0.100 | 0.100 | 0.097 | 0.106 | 0.098 | 0.101 | 0.102 |
| working point | 1141 | 1149 | 1151 | — | — | 1149 | — | 1150 | 1145 |
| T(10⁴ P) (° C.) | | | | | | | | | |
| forming viscosity | 1142 | 1245 | 1267 | — | — | 1250 | — | 1240 | 1180 |
| at 1350° C. (P) | | | | | | | | | |
| fining viscosity at | 261 | 287 | 291 | — | — | 289 | — | 274 | 274 |
| 1550° C. (P) | | | | | | | | | |
| liquidus (° C.) | 901-926 | — | 952-962 | — | 932-942 | — | — | — | — |
| TL softening point | 765.7 | 772.3 | 770 | — | 769.7 | 769.0 | 775.3 | 773.0 | 770.8 |
| (° C.) | | | | | | | | | |
| β-OH (mm⁻¹) | — | — | 0.74 | 0.71 | — | — | — | 0.63 | 0.72 |
| CTE (25-300° C.) | 52.8 | 53.4 | 52.8 | — | 53.7 | 53.2 | 53.6 | 52.8 | 52.8 |
| (·10⁻⁷ K⁻¹) | | | | | | | | | |
| density | 2.329 | 2.341 | 2.34 | — | 2.343 | 2.336 | 2.355 | 2.343 | 2.344 |
| DIN 12116 | — | — | — | 0.73 | — | — | — | — | — |
| (mg/dm²) | | | | | | | | | |
| Class | — | — | — | S2 | — | — | — | — | — |
| ISO 695 (mg/dm²) | — | — | — | 122.7 | — | — | — | — | — |
| Class | — | — | — | A2 | — | — | — | — | — |
| ISO 720 (ml HCl/g | — | — | 0.050 | — | — | — | — | — | — |
| glass) | | | | | | | | | |
| Class | — | — | HGA1 | — | — | — | — | — | — |
| EP. 9.4 (3.2.1 B) | — | 0.05 | — | — | — | 0.051 | — | 0.047 | 0.046 |
| (ml HCl/g glass) | | | | | | | | | |
| Class | — | Type I | — | — | — | Type I | — | Type I | Type I |
| Y (D65) (%) | — | — | 92.31 | — | — | — | — | — | — |
| (1 mm) | | | | | | | | | |
| L* | — | — | 96.9476 | — | — | — | — | — | — |
| a* | — | — | 0.0254 | — | — | — | — | — | — |
| b* | — | — | 0.1415 | — | — | — | — | — | — |
| haze (%) | — | — | 0.31 | — | — | — | — | — | — |

Table 11 shows glass compositions and properties for F-free examples E43, E44, E45, E46, and E47 and comparative examples C7, C8, and C9.

TABLE 11
Fining Packages and Glass Compositions and
Properties for E43-E47, C7, C8, and C9

| Example | E43 | E44 | E45 | E46 | E47 | C7 | C8 | C9 |
|---|---|---|---|---|---|---|---|---|
| Melt ID | F5523 | F5525 | F5527 | F5527 | F5528 | F5527 | F5528 | F5528 |
| Reference FSP | 57-2 | 57 | 61 | 63 | 65 | 64 | 67 | 68 |
| (analyzed wt %) | | | | | | | | |
| SiO₂ | 72.784 | 72.668 | 72.194 | 71.147 | 71.383 | 70.152 | 69.883 | 70.940 |
| B₂O₃ | 11.07 | 11.18 | 11.25 | 11.42 | 11.17 | 13.83 | 11.34 | 11.20 |
| Al₂O₃ | 6.55 | 6.50 | 6.49 | 6.49 | 6.49 | 6.51 | 6.50 | 6.48 |
| TiO₂ | 0.01 | 0.01 | 0.01 | 0.01 | 0.01 | 0.01 | 0.01 | 0.01 |
| Fe₂O₃ | 0.005 | 0.006 | 0.005 | 0.006 | 0.007 | 0.005 | 0.009 | 0.007 |
| BaO | 0.011 | 0.004 | 0.004 | 0.000 | 0.029 | 0.003 | 0.054 | 0.004 |
| CaO | 1.33 | 1.33 | 1.31 | 1.33 | 1.24 | 1.35 | 1.22 | 3.08 |
| Na₂O | 6.86 | 6.93 | 7.36 | 8.30 | 6.84 | 6.77 | 6.78 | 6.87 |
| K₂O | 1.09 | 1.11 | 1.11 | 1.08 | 2.57 | 1.10 | 3.96 | 1.11 |
| MgO | 0.02 | 0.02 | 0.02 | 0.02 | 0.02 | 0.02 | 0.02 | 0.06 |
| Cl | 0.020 | 0.017 | 0.016 | 0.016 | 0.018 | 0.017 | 0.018 | 0.018 |
| F | 0 | 0.001 | 0.002 | 0 | 0 | 0.002 | 0 | 0 |
| CeO₂ | 0.15 | 0.13 | 0.13 | 0.10 | 0.13 | 0.13 | 0.11 | 0.13 |
| SnO₂ | 0.100 | 0.095 | 0.100 | 0.087 | 0.095 | 0.102 | 0.097 | 0.096 |
| working point T(10⁴ P) | 1161 | 1160 | — | — | — | 1130 | — | — |
| (° C.) | | | | | | | | |
| forming viscosity at | 1420 | 1400 | — | — | — | 1017 | — | — |
| 1350° C. (P) | | | | | | | | |
| fining viscosity at | 318 | 315 | — | — | — | 240 | — | — |
| 1550° C. (P) | | | | | | | | |
| liquidus (° C.) | — | 936-954 | — | — | — | — | — | — |
| TL softening point | 781.7 | 778.0 | 771.3 | 764.0 | 771.3 | 758.7 | 761.7 | 774.3 |
| (° C.) | | | | | | | | |
| β-OH (mm⁻¹) | 0.66 | 0.66 | — | — | — | — | — | |
| CTE (25-300° C.) | 52.7 | 52.3 | 54.9 | 58.1 | 58.2 | 53.0 | 63.6 | 55.5 |
| (·10⁻⁷ K⁻¹) | | | | | | | | |
| density | 2.338 | 2.339 | 2.351 | 2.374 | 2.366 | 2.325 | 2.39 | 2.369 |
| refractive index n_{D} | 1.49069 | — | — | — | — | — | — | — |
| (589 nm) | | | | | | | | |
| DIN 12116 (mg/dm²) | 0.49 | — | — | — | — | — | — | — |
| Class | S1 | — | — | — | — | — | — | — |
| ISO 695 (mg/dm²) | 110.4 | — | — | — | — | — | — | — |
| Class | A2 | — | — | — | — | — | — | — |
| EP. 9.4 (3.2.1 B) (ml | — | — | 0.046 | — | — | — | — | 0.069 |
| HCl/g glass) | | | | | | | | |
| Class | — | — | Type I | — | — | — | — | Type I |

Fining Performances of F-Free Modified Composition and F-Free Low SnO₂ Modified Composition

The fining performance of an F-free modified composition (E40: FSP 75) and of an F-free low SnO₂ modified composition (FSP 78) has been compared to conventional borosilicate tank glass (FSP 56) to study whether the composition change (addition of Na₂O and B₂O₃ and reduction of SnO₂) impacts fining. The FSP 75 composition was selected to compare fining performances of glasses having very close high temperature viscosity (working point 1150° C. and 1155° C.) and TL values (773° C. and 770° C.).

Method 1, melting Cycle A, and sample preparation method 1.2 were used in melts F5543 and F5550 with D equals 30 min. Results are provided in Table 12 and show similar fining performances for the compositions: the Reference (FSP 56) vs the F-free modified (FSP 75) and the Reference (FSP 56) vs the F-free low SnO₂ modified (FSP 78). Due to furnace inhomogeneity, the results for examples D48 and E50 can be compared, and results for examples D49 and E51 can be compared. Due to furnace inhomogeneity, the results for examples E52 and E54 can be compared, and results for compositions E53 and E55 can be compared.

Table 12 shows results of Melts F5543 and F5550 with D equals 30 min showing similar fining performances for the reference composition (FSP 56) and the F-free modified composition (FSP 75) and similar fining performances for the reference composition (FSP 56) and the F-free low SnO₂ modified composition (FSP 78).

TABLE 12
Fining Packages and Compositions of
Melts F5543 and F5550 for D48, D49, and E50-E55

| Melt | F5543 | | | | F5550 | | | |
|---|---|---|---|---|---|---|---|---|
| Example | D48 | D49 | E50 | E51 | E52 | E53 | E54 | E55 |
| Reference FSP | 56-1 | 56-2 | 75-1 | 75-2 | 56-1 | 56-2 | 78-1 | 78-2 |
| (analyzed wt %) | | | | | | | | |
| SiO₂ | 72.896 | 72.550 | 72.268 | 72.310 | 72.978 | 73.646 | 72.699 | 72.849 |
| B₂O₃ | 10.83 | 11.09 | 11.53 | 11.5 | 10.75 | 10.27 | 11.26 | 11.19 |
| Al₂O₃ | 6.55 | 6.53 | 6.5 | 6.5 | 6.57 | 6.72 | 6.59 | 6.53 |
| TiO₂ | 0.01 | 0.01 | 0.01 | 0.01 | 0.01 | 0.01 | 0.01 | 0.01 |
| Fe₂O₃ | 0.005 | 0.005 | 0.005 | 0.004 | 0.005 | 0.005 | 0.005 | 0.005 |
| BaO | 0.011 | 0.011 | 0.011 | 0.011 | 0 | 0 | 0 | 0 |
| CaO | 1.33 | 1.32 | 1.32 | 1.31 | 1.32 | 1.36 | 1.28 | 1.32 |
| Na₂O | 6.78 | 6.91 | 6.93 | 6.92 | 6.84 | 6.43 | 6.83 | 6.77 |
| K₂O | 1.12 | 1.12 | 1.12 | 1.12 | 1.12 | 1.14 | 1.13 | 1.12 |
| MgO | 0.02 | 0.02 | 0.02 | 0.03 | 0.01 | 0.02 | 0.02 | 0.02 |
| Cl | 0.018 | 0.016 | 0.019 | 0.018 | 0.017 | 0.017 | 0.018 | 0.017 |
| F | 0.170 | 0.160 | 0.002 | 0 | 0.158 | 0.165 | 0.002 | 0.004 |
| CeO₂ | 0.16 | 0.15 | 0.16 | 0.16 | 0.13 | 0.13 | 0.13 | 0.13 |
| SnO₂ | 0.109 | 0.109 | 0.108 | 0.109 | 0.096 | 0.096 | 0.033 | 0.034 |
| sum seeds/cm³ | 408 | 153 | 203 | 65 | 353 | 1232 | 2516 | 653 |

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the aspects of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, and like aspects, and ranges thereof, are for illustration only; they do not exclude other defined values or other values within defined ranges. The systems, kits, and/or methods of the disclosure can include any value or any combination of the values, specific values, more specific values, and preferred values described herein, including explicit or implicit intermediate values and ranges.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the disclosed aspects. Since modifications, combinations, sub-combinations and variations of the disclosed aspects incorporating the spirit and substance of the aspects may occur to persons skilled in the art, the disclosed aspects should be construed to include everything within the scope of the appended claims and their equivalents.

What is claimed is:

1. A fining package for a glass composition comprising:
cerium dioxide (CeO₂) in an amount of 0.08 to 0.5 wt % of the glass composition, and
tin oxide (SnO₂) in an amount of 0.02 to 0.23 wt % of the glass composition.

2. The fining package of claim 1, further comprising chloride (Cl) in an amount of 0 to 0.03 wt % of the glass composition.

3. The fining package of claim 1, wherein the fining package is Cl-free.

4. The fining package of claim 1, wherein the fining package is F-free.

5. The fining package of claim 1, wherein the glass composition comprises:
SiO₂ in an amount of 70 to 76 wt % of the glass composition;
B₂O₃ in an amount of 9 to 13.5 wt % of the glass composition;
Al₂O₃ in an amount of 4 to 8 wt % of the glass composition;
TiO₂ in an amount of 0 to 0.1 wt % of the glass composition;
Fe₂O₃ in an amount of 0 to 0.1 wt % of the glass composition;
BaO in an amount of 0 to 0.1 wt % of the glass composition;
CaO in an amount of 0 to 3 wt % of the glass composition;
Na₂O in an amount of 5 to 8.5 wt % of the glass composition;
K₂O in an amount of 0.5 to 3 wt % of the glass composition;
MgO in an amount of 0 to 1 wt % of the glass composition;
Cl in an amount of 0 to 0.03 wt % of the glass composition;
F in an amount of 0 to 0.02 wt % of the glass composition;
CeO₂ in an amount of 0.08 to 0.5 wt % of the glass composition;
SnO₂ in an amount of 0.02 to 0.23 wt % of the glass composition; and
ZrO₂ in an amount of 0 to 0.08 wt % of the glass composition.

6. The fining package of claim 5, wherein the glass composition comprises:
SiO₂ in an amount of 70 to 74 wt % of the glass composition;
B₂O₃ in an amount of 10 to 13.5 wt % of the glass composition;
Al₂O₃ in an amount of 5 to 7 wt % of the glass composition;
TiO₂ in an amount of 0 to 0.03 wt % of the glass composition;
Fe₂O₃ in an amount of 0 to 0.04 wt % of the glass composition;
BaO in an amount of 0 to 0.04 wt % of the glass composition;
CaO in an amount of 0.5 to 2.3 wt % of the glass composition;
Na₂O in an amount of 6.5 to 7.5 wt % of the glass composition;
K₂O in an amount of 1.0 to 1.8 wt % of the glass composition;
MgO in an amount of 0 to 0.1 wt % of the glass composition;
Cl in an amount of 0.01 to 0.03 wt % of the glass composition;
F in an amount of 0 to 0.02 wt % of the glass composition;
CeO₂ in an amount of 0.08 to 0.2 wt % of the glass composition;
SnO₂ in an amount of 0.02 to 0.12 wt % of the glass composition; and
ZrO₂ in an amount of 0 to 0.08 wt % of the glass composition.

7. The fining package of claim 6, wherein the glass composition comprises:
SiO₂ in an amount of 70 to 73 wt % of the glass composition;
B₂O₃ in an amount of 10.5 to 13.2 wt % of the glass composition;
Al₂O₃ in an amount of 5 to 7 wt % of the glass composition;
TiO₂ in an amount of 0 to 0.03 wt % of the glass composition;
Fe₂O₃ in an amount of 0 to 0.04 wt % of the glass composition;
BaO in an amount of 0 to 0.04 wt % of the glass composition;
CaO in an amount of 1 to 2.3 wt % of the glass composition;
Na₂O in an amount of 6.5 to 7.3 wt % of the glass composition;
K₂O in an amount of 1.0 to 1.5 wt % of the glass composition;
MgO in an amount of 0 to 0.1 wt % of the glass composition;
Cl in an amount of 0.01 to 0.02 wt % of the glass composition;
F in an amount of 0 to 0.02 wt % of the glass composition;
CeO₂ in an amount of 0.08 to 0.2 wt % of the glass composition;
SnO₂ in an amount of 0.02 to 0.12 wt % of the glass composition; and
ZrO₂ in an amount of 0 to 0.08 wt % of the glass composition.

8. The fining package of claim 1, wherein the glass composition comprises a borosilicate glass composition.

9. The fining package of claim 1, wherein the glass composition comprises an aluminosilicate glass composition.

10. The fining package of claim 1, wherein the glass composition is used to form glass tubing.

11. The fining package of claim 10, wherein the glass tubing is used to form a pharmaceutical packaging.

12. The fining package of claim 11, wherein the pharmaceutical packaging comprises an ampoule.

13. The fining package of claim 1, wherein the fining package comprises a fining viscosity at 1550° C. of less than 350 P.

14. The fining package of claim 1, wherein the fining package is used to produce a glass article having a TL softening point of 760° C. to 782° C.

15. The fining package of claim 1, wherein the fining package is used to produce a glass article having a coefficient of thermal expansion (CTE) of 50-59.10⁻⁷ K⁻¹.

16. The fining package of claim 15, wherein the CTE is measured at 25° C. to 300° C.

17. A method of fining glass for forming pharmaceutical packaging comprising:
adding the fining package of claim 1 to a glass composition to remove gas bubbles; and
forming glass tubing from the fined glass composition.

18. The method of claim 17, further comprising forming a pharmaceutical packaging from the glass tubing.

19. The method of claim 18, wherein the pharmaceutical packaging comprises a pharmaceutical ampoule.
